(19) United States
(12) Patent Application Publication
(10) Pub. No.: US 2023/0360066 A1
(43) Pub. Date: Nov. 9, 2023

(54) Machine-Learning-Based Prediction of Account Outcome

(71) Applicant: 6SENSE INSIGHTS, INC., San Francisco, CA (US)

(72) Inventors: Daniel Carmody, Durham, NC (US); Akshay Shah, Pune (IN); Yulia Tyutina, Minneapolis, MN (US); Amar Doshi, Sunnyvale, CA (US); Viral Bajaria, Redwood City, CA (US)

(21) Appl. No.: 18/142,744

(22) Filed: May 3, 2023

Related U.S. Application Data
(60) Provisional application No. 63/337,911, filed on May 3, 2022.

(51) Int. Cl. G06Q 30/0202; G06N 5/022; G06N 7/01

(52) U.S. Cl. CPC G06Q 30/0202; G06N 5/022; G06N 7/01

(57) ABSTRACT

The determination of an account outcome, such as a renewal, upsell, or cross-sell, for a product subscription is not presently capable of automation or scaling. Accordingly, disclosed embodiments automate this determination, in a scalable manner, using a trained predictive machine-learning model. In particular, values for a set of features of a customer account are extracted and input to a predictive machine-learning model to identify the probability of an account outcome. This probability may then be used in one or more downstream functions, such as for reports, alerts, account segmentation, marketing orchestration, sales intelligence, determining a next best action, and/or the like.

### CROSS-REFERENCE TO RELATED APPLICATIONS

This application claims priority to U.S. Provisional Patent App. No. 63/337,911, filed on May 3, 2022, which is hereby incorporated herein by reference as if set forth in full.

### BACKGROUND

### Field of the Invention

The embodiments described herein are generally directed to machine learning, and, more particularly, to predicting an account outcome (e.g., renewal, upsell, cross-sell, etc.) using a machine-learning model.

### Description of the Related Art

Customer success and revenue teams rely on a number of indicators to assess the health of customer accounts, in order to determine the likelihood that a customer will renew its account. These indicators are often either subjective (e.g., assigned by a customer success manager) or difficult to analyze, and typically require in-depth technical analysis of historical results. As a result, determining the likelihood that a customer will renew its account is not capable of being automated and is not scalable.

### SUMMARY

Systems, methods, and non-transitory computer-readable media are disclosed to predict an account outcome (e.g., renewal or churn, upsell, cross-sell, etc.) using a machine-learning model.

In an embodiment, a method comprises using at least one hardware processor to: receive data for at least one customer account; extract feature values for a set of features for the at least one customer account from the received data; apply at least one predictive machine-learning model to the feature values to identify a probability of an account outcome, wherein the at least one predictive machine-learning model has been trained on a training dataset comprising a plurality of labeled feature vectors, wherein each of the plurality of labeled feature vectors comprises values for the set of features and is labeled with a ground-truth account outcome; and provide an output, representing the identified probability of the account outcome, to at least one downstream function.

The received data may comprise snapshot data for the at least one customer account, wherein the snapshot data comprise a time series of snapshots that each represent a profile of the at least one customer account at a point in time.

The received data may comprise transactional data for the at least one customer account, wherein the transactional data comprise a time series of activities associated with the at least one customer account. The activities may comprise visiting a website. The activities may comprise engaging with a representative of an organization with which the at least one customer has a contract.

The at least one predictive machine-learning model may be a plurality of predictive machine-learning models that are each trained on a separate training dataset, wherein the plurality of labeled feature vectors in each separate training dataset comprise values for a different set of features than in the separate training dataset used to train any others of the plurality of predictive machine-learning models. The received data may comprise snapshot data and transactional data for the at least one customer account, wherein the snapshot data comprise a time series of snapshots that each represent a profile of the at least one customer account at a point in time, wherein the transactional data comprise a time series of activities associated with the at least one customer account, wherein a first one of the plurality of predictive machine-learning models is trained on a first separate training dataset comprising profile features derived from the snapshot data, and wherein a second one of the plurality of predictive machine-learning models is trained on a second separate training dataset comprising behavioral features derived from the transactional data. The first predictive machine-learning model may output a first probability value of the account outcome, and the second predictive machine-learning model may output a second probability value of the account outcome. The method may further comprise using the at least one hardware processor to aggregate at least the first probability value and the second probability value into a composite probability value, wherein the output, provided to the at least one downstream function, is based on the composite probability value. The composite probability value may be a weighted average of at least the first probability value and the second probability value. The output, provided to the at least one downstream function, may comprise both a first value based on the first probability value, and a second value based on the second probability value.

The at least one predictive machine-learning model may be a classification model, wherein identifying the probability of an account outcome comprises identifying the probability that the account outcome is within at least one of a plurality of classes.

The account outcome may be a renewal of a contract. The account outcome may be an upsell of a product. The account outcome may be a cross-sell of a product.

The method may further comprise using the at least one hardware processor to train the at least one predictive machine-learning model on the training dataset.

The received data may comprise data received from a plurality of different sources, wherein the plurality of different sources comprise one or more of a customer relationship management system, a marketing automation platform, a support ticketing system, a customer success system, product usage data, online activity data, customer intent data, or customer satisfaction data. The method may further comprise using the at least one hardware processor to: for each of a plurality of customer accounts, master the data received from the plurality of different sources for the customer account under a unique cross-platform identifier; and store the mastered data in a master database, wherein receiving the data for the at least one customer comprises retrieving the data from the master database based on the unique cross-platform identifier of the at least one customer.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a process for training a predictive machine-learning model to automatically determine the probability of an account outcome, according to an embodiment;

FIG. 4 illustrates a process for operating a predictive machine-learning model to automatically determine the probability of an account outcome, according to an embodiment; and

FIG. 5 illustrates an example data flow for the operation of a predictive machine-learning model, according to an embodiment.

### DETAILED DESCRIPTION

In an embodiment, systems, methods, and non-transitory computer-readable media are disclosed for predict an account outcome (e.g., renewal or churn, upsell, cross-sell, etc.) using a machine-learning model. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. Example Infrastructure

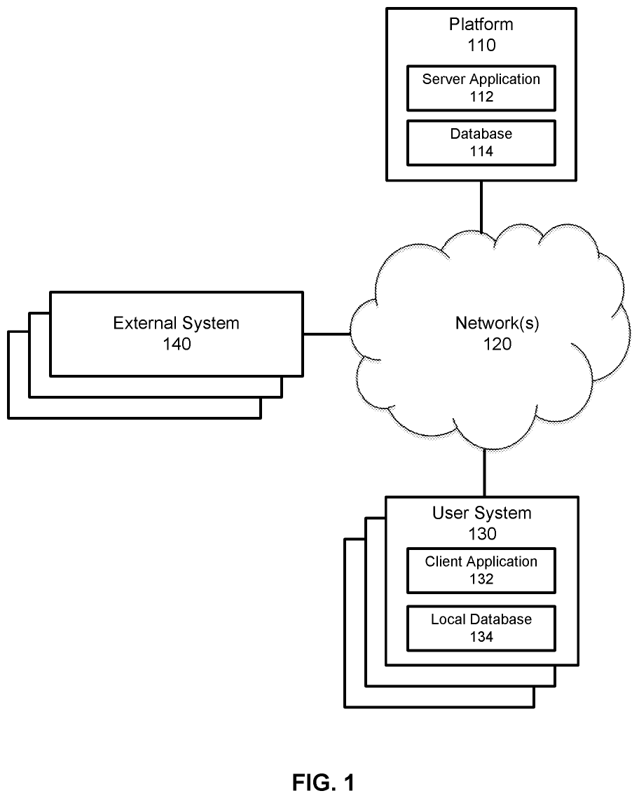

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may execute a server application 112 and provide access to a database 114. In addition, platform 110 may be communicatively connected to one or more user systems 130 via one or more networks 120. Platform 110 may also be communicatively connected to one or more external systems 140 (e.g., other platforms, including third-party data sources, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one database 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user system 130 will comprise the workstation or personal computing device of an agent (e.g., sales or marketing representative, data scientist, etc.) of a organization with a user account on platform 110, which may be referred to herein as an “organizational user,” or an agent (e.g., programmer, developer, etc.) of the operator of platform 110, which may be referred to herein as an administrative user. It should be understood that an organizational user may actually comprise a plurality of users, under a single organizational user account, with different roles and/or permissions governed by individual credentials. Each user system 130 may execute a client application 132 with access to a local database 134.

External system(s) 140 may also comprise any type or types of computing devices capable of wired and/or wireless communication, including those described above. However, it is generally contemplated that external system 140 will comprise a server-based system that hosts customer relationship management (CRM) software (e.g., as offered by Salesforce, Inc. of San Francisco, California), marketing automation platform (MAP) software (e.g., as offered by Marketo, Inc. of San Mateo, California), or website, and/or the like of an organizational user, or the system of a third-party data vendor or other data source. External system 140 may send data to platform 110 (e.g., contacts or leads at existing or potential customers of the organizational user, website or other online activity, offline activity, marketing activity, etc.) and/or receive data from platform 110 (e.g., recommendations or other information about contacts or leads, new leads, marketing tactics, etc.). In this case, external system 140 may “push” and/or “pull” the data through an application programming interface (API) of platform 110, and/or platform 110 may “push” and/or “pull” the data through an API of external system 140.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 may transmit or serve one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in database 114. It should be understood that platform 110 may also respond to other requests from user system(s) 130 that are unrelated to the graphical user interface.

Platform 110 may comprise, be communicatively coupled with, or otherwise have access to database 114. For example, platform 110 may comprise one or more database servers which manage database 114. Server application 112 executing on platform 110 and/or client application 132 executing on user system 130 may submit data (e.g., user data, form data, etc.) to be stored in database 114, and/or request access to data stored in database 114. Any suitable database may be utilized, including without limitation MySQL™, Oracle™ IBM™, Microsoft SQL™, Access™, PostgreSQL™, MongoDB™, and/or the like, including cloud-based databases and/or proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an API which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user systems 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

2. Example Processing System

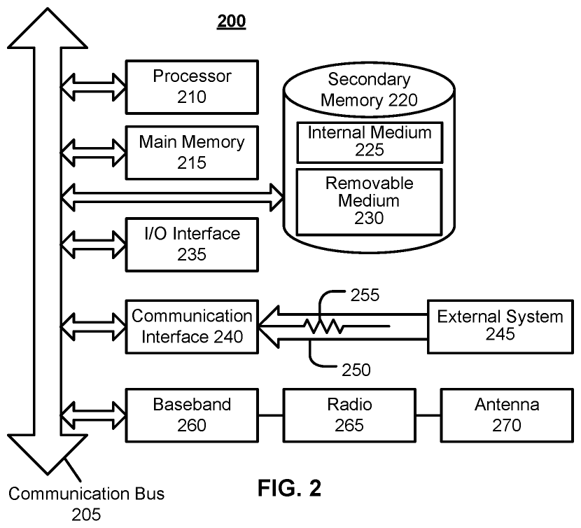

FIG. 2 is a block diagram illustrating an example wired or wireless processing system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or supporting data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or supporting data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

Any of the described processes may be embodied in one or more software modules that are executed by processor(s) 210 of one or more processing systems 200, for example, as a service or other software application (e.g., server application 112, client application 132, and/or a distributed application comprising both server application 112 and client application 132), which may be executed wholly by processor(s) 210 of platform 110, wholly by processor(s) 210 of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component is for ease of description. Specific functions can be moved from one component to another component without departing from the disclosure.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

3. Training

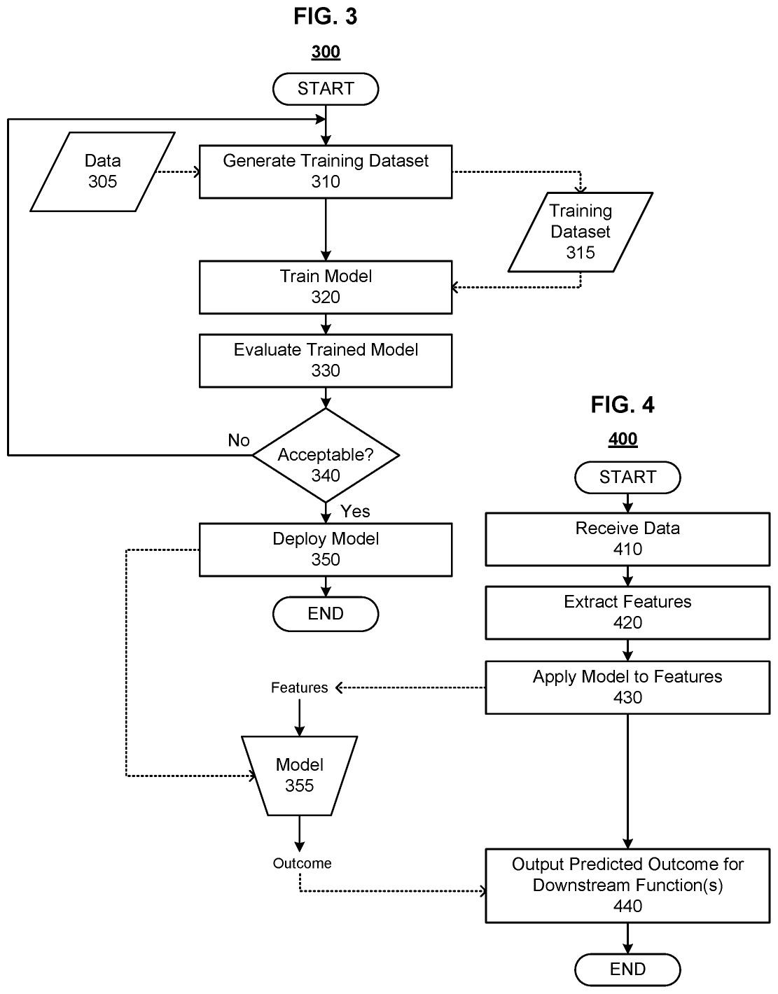

FIG. 3 illustrates a process 300 for training a predictive machine-learning model to automatically determine the probability of an account outcome, according to an embodiment. Process 300 may be performed by or under the control of an administrative user, to produce a machine-learning model that can be used to process account data in an operational stage on platform 110.

The input to process 300 may be a set of data 305, representing historical snapshot data and/or transactional data for a plurality of customer accounts for a plurality of organizational users and/or non-users. The customer accounts for a particular organization represent customers of one or more products of that organization, as tracked by the organization, and should not be confused with an organizational user's user account with platform 110. Data 305 may be extracted from database 114 and/or one or more external systems 140, which may comprise CRM systems for one or more organizations. For example, data 305 may be extracted from CRM objects for customer accounts in the CRM system(s) or other external system(s) 140 of one or more organizational users. In an embodiment, data 305 are extracted from the CRM objects of a plurality of different organizations to produce a robust set of data 305. Prior to being used for training, data 305 may be cleaned and normalized.

Snapshot data comprise snapshots. Each snapshot may represent the profile of a customer account at a particular point in time. The profile of a customer account may represent the state of the customer account and may include, without limitation, the value of a health metric for the customer account, a net promoter score (NPS) for the customer account, the value of a product usage metric for the customer account, firmographic information for the customer account, technographic information for the customer account, and/or the value(s) of one or more other profile characteristics of the customer account. Over time, a time series of snapshots may be collected for each customer account, to produce a time series of snapshots for each customer account. For example, a snapshot may be collected for each customer account on a daily basis, to build a day-delimited time series of snapshots for each customer account. Advantageously, these time series of snapshots represent historical data that can be used for prediction of a future account outcome. In particular, these historical time series of snapshots may be compiled into data 305. Each snapshot may comprise a record that includes a unique identifier of the particular snapshot, one or more values representing the profile of the customer account in the particular snapshot, and a timestamp representing at least the date on which the snapshot was derived. Each snapshot record may be associated with a particular customer account.

Transactional data may comprise a time series of activities for each of a plurality of customer accounts represented in data 305. In general, the activities of a customer account are the actions of one or more agents (e.g., employees) of the customer account on behalf of the customer account. Examples of activities include, without limitation, online activities, such as visiting a website, submitting a web form, opening an email message, sending an email message, downloading an electronic document (e.g., a whitepaper, manual, etc.), requesting a price quote, otherwise engaging with a representative of an organizational user online, and/or the like, and/or offline activities, such as visiting a store, attending a trade show, answering a telephone call, initiating a telephone call, otherwise engaging with a representative of an organizational user offline, and/or the like. For each activity, the transactional data may include an activity record that comprises a unique identifier of the particular instance of the activity, a name, description, or other identifier of the type of activity, and a timestamp representing at least the date of the activity. Each activity record may be associated with a particular customer account.

In subprocess 310, a training dataset 315 is generated from data 305. In particular, the values of a set of features may be derived from data 305 using standard feature engineering. Feature values may be derived from the profiles and/or time series of profiles in the snapshot data and/or the activities and/or time series of activities in the transactional data of data 305.

In the case of the snapshot data, a value of a profile characteristic in one or more snapshots for each customer account may be extracted as feature value(s), a value of a profile characteristic may be aggregated over a time series of snapshots for each customer account as a feature value, and/or a feature value may otherwise be derived from one or more profile characteristics in one or more snapshots for each customer account. Features derived from snapshot data may be referred to herein as “profile features,” since they reflect the profile of a particular customer account.

In the case of transactional data, one or more sequences of activities in a time series may be extracted as feature value(s), activities may be counted or otherwise aggregated by type to produce feature value(s), and/or the like. Features derived from transactional data may be referred to herein as “behavioral features,” since they reflect the behavior of a particular customer account. Examples of behavioral features include, without limitation, the number of active users associated with the customer account, the number of activities performed by the customer account (e.g., within a most recent past time window), the most recent time an activity was performed by the customer account, the most common activity performed by the customer account (e.g., within a most recent past time window), the job functions and/or job levels associated with an agent who has performed the most activities (e.g., within a most recent past time window), and/or the like.

In an embodiment, a taxonomy may be applied to the activities to group activities of the same type or similar types together. Advantageously, this reduces the cardinality of the transactional data. Embodiments of taxonomies that may be used are described, for example, in U.S. Patent Publication No. 2022/0383125, published on Dec. 1, 2022, and U.S. Patent Publication No. 2022/0391453, published on Dec. 8, 2022, which are both hereby incorporated herein by reference as if set forth in full, and which may be collectively referred to herein as “the taxonomy references.”

For each customer account in data 305, training dataset 315 may comprise at least a subset of the profile features and/or behavioral features derived for that customer account as a feature vector. Training dataset 315 could also comprise other features, unrelated to the profile or behavior of the customer accounts, for each customer account. Each feature vector comprises values for the set of features being utilized.

In addition, each feature vector may be labeled with a target value. Each target value may represent a ground-truth account outcome for the customer account associated with the corresponding feature vector. An account outcome may be a won renewal, a lost renewal (also referred to as a “churn”), a won upsell, a lost upsell, a won cross-sell, a lost cross-sell, or the like.

As used herein, the term “renewal” refers to an action by a customer to renew a contract (e.g., subscription) for a product offered by an organizational user of platform 110. It should be understood that a product may be a good or a service. If a renewal is “won,” the renewal is successful and the organizational user retained the customer. If a renewal is “lost,” the event becomes a “churn,” which refers to an action or failure to act by the customer that results in the expiration or termination of the contract without a new contract in place. Business-to-business (B2B) companies often sign multi-month or multi-year contracts, with a renewal or churn event occurring on or before the end date of the contract.

The term “upsell” refers to an action by a customer to purchase more than the product in an original contract (e.g., an add-on or complementary product). Similarly, the term “cross-sell” refers to an action by a customer to purchase a different product in addition to the product in the original contract. If an upsell or cross-sell is “won,” the customer agreed to the upsell or cross-sell (e.g., purchased more of a product, or purchased an additional product). If an upsell or cross-sell is “lost,” the customer was offered an upsell or cross-sell, but ultimately rejected the offer.

Renewals, upsells, and/or cross-sells may be tracked as opportunities (i.e., prospective business deals) within a CRM system, and as different types of opportunities than a new business opportunity. As discussed above, renewals, upsells, and cross-sells can either be won, which represents a successful or positive account outcome, or lost, which represents an unsuccessful or negative account outcome. Each account outcome may be represented in data 305 as an outcome record comprising a unique identifier of the particular outcome, an outcome flag, representing whether the account outcome was positive (won) or negative (lost), and a timestamp representing at least the date of the outcome (e.g., the date on which the renewal, upsell, or cross-sell was won or lost). Each outcome record may be associated with a particular customer account.

The feature vector may comprise the values of a set of features corresponding to the target value with which the feature vector is labeled. In particular, a dataset of account outcomes may be combined with the snapshot and/or transactional data in data 305 to produce the labeled feature vectors. For example, the date of a renewal or churn may be identified in the account outcomes, and an indication of the renewal or churn may be added as a label to a feature vector comprising the values of the set of features on, just before, or within a past time window preceding that date. Similarly, the date of a successful upsell or failed upsell attempt may be identified in the account outcomes, and an indication of the successful upsell or failed upsell may be added as a label to a feature vector comprising the values of the set of features on, just before, or within a past time window preceding that date. Similarly, the date of a successful cross-sell or failed cross-sell attempt may be identified in the account outcomes, and an indication of the successful cross-sell or failed cross-sell may be added as a label to a feature vector comprising the values of the set of features on, just before, or within a past time window preceding that date. In any of these cases, it should be understood that training dataset 315 comprises or consists of the labeled feature vectors.

The particular features that are used in training dataset 315 may depend on the particular type of account outcome to be predicted by the model. For example, for a model to predict the probability of an upsell, the features may incorporate one or more metrics of product usage by the customer account. Product usage describes how a customer account engages with a product of the organizational user. Product usage may be measured from transactional data or pre-aggregated metrics in data 305. Alternatively, the features may consist entirely of keywords from keyword-based research performed by the customer accounts.

In subprocess 320, the model is trained using training dataset 315. In particular, the model may be trained from the labeled feature vectors in training dataset 315, using supervised learning. In an embodiment, the model may be a classification model that outputs a probability vector representing the probability that the input feature vector produces an outcome that falls into one or each of a plurality of classes. It should be understood that the probability vector may comprise or consist of a probability for each possible class. For example, in the case that the target is a renewal, the classes may consist of “renew” and/or “churn.” In the case that the target is an upsell, the classes may consist of “upsell” and/or “no upsell.” In the case that the target is a cross-sell, the classes may consist of “cross-sell” and/or “no cross-sell.” The classification model may be a Random Forest classifier, an XGBoost classifier, or the like.

Alternatively, the model may be a different type of model. For example, at one end of the spectrum of complexity, the model may comprise a metrics-based sorting algorithm. At the other end of the spectrum of complexity, the model may be a deep-learning neural network or an even more complex model.

In subprocess 330, the model, trained in subprocess 320, may be evaluated. The evaluation may comprise validating and/or testing the model using a portion of training dataset 315 that was not used to train the model in subprocess 320. The result of subprocess 330 may be a performance measure for the model, such as an accuracy of the model. The evaluation in subprocess 330 may be performed in any suitable manner.

In subprocess 340, it is determined whether or not the model, trained in subprocess 320, is acceptable based on the evaluation performed in subprocess 330. For example, the performance measure from subprocess 340 may be compared to a threshold or one or more other criteria. If the performance measure satisfies the criteria (e.g., is greater than or equal to a predefined threshold), the model may be determined to be acceptable (i.e., “Yes” in subprocess 340). Conversely, if the performance measure does not satisfy the criteria (e.g., is less than the predefined threshold), the model may be determined to be unacceptable (i.e., “No” in subprocess 340). When the model is determined to be acceptable (i.e., “Yes” in subprocess 340), process 300 may proceed to subprocess 350. Otherwise, when the model is determined to be unacceptable (i.e., “No” in subprocess 340), process 300 may return to subprocess 310 to retrain the model (e.g., using a new training dataset 315).

In subprocess 350, the trained model may be deployed as model 355. Model 355 may be a distribution-based model. In an embodiment, model 355 receives a feature vector of a customer account as an input, and outputs the most probable account outcome, a probability of a particular account outcome, a probability vector comprising the probability of each of a plurality of possible classes of the account outcome, or the like. Model 355 may be deployed by moving model 355 from a development environment to a production environment. For example, model 355 may be made available at an address on platform 110 (e.g., in a microservice architecture) that is accessible to one or more downstream functions (e.g., other service or application) that utilize model 355.

Notably, more data 305 may be collected over time. For example, additional snapshots may be recorded, additional activities may be collected, and/or the like for customer accounts. Thus, process 300 may be re-executed periodically, with the new data 305 in training dataset 315, to retrain or update model 355.

4. Operation

FIG. 4 illustrates a process 400 for operating a predictive machine-learning model 355 to automatically determine the probability of an account outcome, according to an embodiment. Process 400 may be executed as a subroutine within a larger software service or application. Alternatively, process 400 may be executed as its own service (e.g., in a microservice architecture), which is accessible at a particular address to other services or applications. In either case, the input to process 400 may be a feature vector, comprising values for the same set of features that was used in the labeled feature vectors in training dataset 315. The output of process 400 may be the most probable account outcome, a probability of a particular account outcome, a probability vector comprising the probability of each of a plurality of possible classes of the account outcome, or the like, predicted for that the values of that set of features.

Initially, in subprocess 410, data may be received. The data may represent a single customer account or a batch of a plurality of customer accounts. In an embodiment, the data may be passed as an input parameter by a caller of process 400. The data may comprise snapshot data and/or transactional data, as described above, and/or other types of data.

In subprocess 420, values of features may be extracted from the data received in subprocess 410. In particular, for each customer account represented in the data, a feature vector may be extracted. Each feature vector may comprise values for the same set of features as in training dataset 315, and may be extracted from the data in the same or similar manner as in subprocess 310.

In subprocess 430, model 355, which was trained in subprocess 320 of process 300 and deployed by subprocess 350 of process 300, may be applied to the feature vector(s), output by subprocess 420. In particular, each feature vector is input into model 355. Model 355 may be applied to individual feature vectors or, when there are a plurality of customer accounts to be processed, batches of feature vectors, for faster processing.

In an embodiment, model 355 identifies the probable account outcome for each customer account in the data received in subprocess 410. This account outcome may be output as the class with the highest probability, the probability of a single class, a probability vector comprising a probability for each possible class, or the like, as discussed elsewhere herein. In any case, the output of model 355 indicates or otherwise identifies a probability of at least one particular account outcome (e.g., the positive account outcome or the negative account outcome).

In an embodiment in which the model outputs a probability value of one or more classes, the output may be binned into one of a plurality of buckets, such as “strong,” “medium,” or “weak,” based on different ranges of the probability value for a particular class. The buckets may be mapped to ranges of probability values based on expected conversion, by capacity to intervene, or the like. For example, the strong bucket may be used for the top third (or other percentage) of the range of probability values for a won renewal, upsell, or cross-sell, to represent a strong likelihood of a positive account outcome. Similarly, the medium bucket may be used for the middle third (or other percentage) of the range of probability values for a won renewal, upsell, or cross-sell, to represent a moderate likelihood of a positive account outcome. Similarly, the weak bucket may be used for the bottom third (or other percentage) of the range of probability values for a won renewal, upsell, or cross-sell, to represent a low likelihood of a positive account outcome. These buckets may be more useful outputs than probability values for certain business applications (e.g., which may require human comprehension). It should be understood that the mappings of buckets to ranges of probability values may be reversed if the probability value, output by model 355, represents the inverse class (e.g., lost renewal or churn, lost upsell, or lost cross-sell).

In subprocess 440, the direct output of model 355, or an indirect output derived from the output of model 355, may be output to one or more downstream functions. For example, the output may be returned as a response to the caller of process 400, so that it may be used by the caller for one or more downstream functions, as discussed elsewhere herein.

Process 400 may be performed for any number of customer accounts. For example, process 400 may be performed iteratively on the data from one or more batches representing a plurality of customer accounts, and/or process 400 may be performed iteratively on the data for individual customer accounts. Thus, it should be understood that process 400 could be performed for each of a plurality of customer accounts.

5. Data Flow

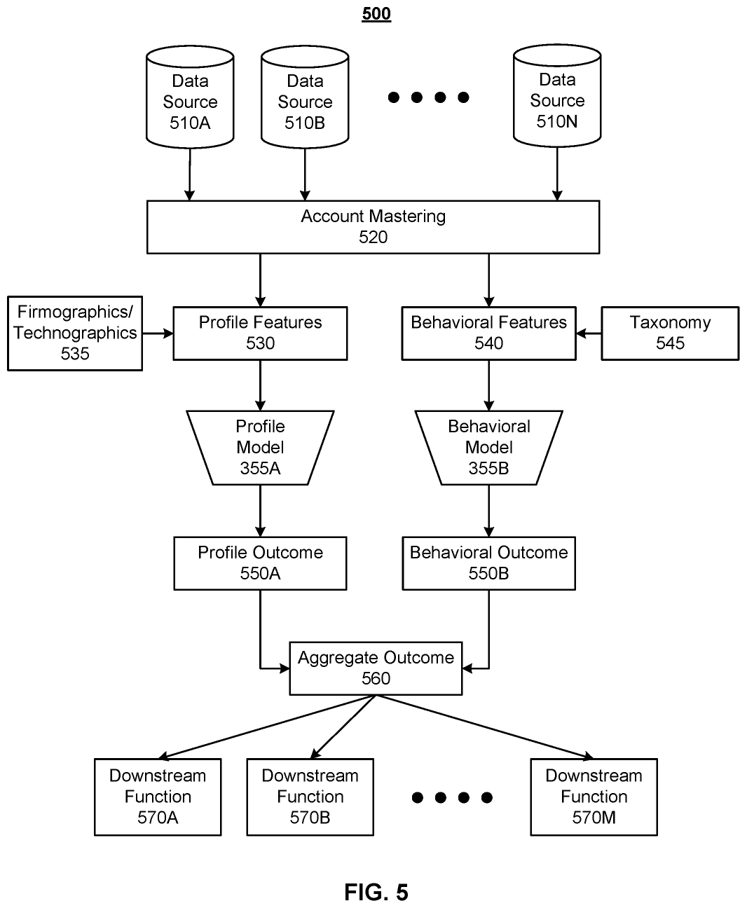

FIG. 5 illustrates an example data flow 500 for the operation of a predictive machine-learning model 355 in process 400, according to an embodiment. Notably, a plurality of distinct and independent models 355 are used in the illustrated example of data flow 500. For example, a profile model 355A may be trained on profile features from data 305 in a first execution of process 300, and a behavioral model 355B may be trained on transactional features from data 305 in a second execution of process 300. It should be understood that any number of models 355 may be individually trained in this manner, in separate executions of process 300, using different sets of features to predict the same account outcome. The sets of features used for different models 355 may be non-overlapping, as in the case of snapshot features and transactional features, or may be overlapping (e.g., one or more features may be used for two or more different models 355). In general, each model 355 may be trained on a training dataset in which the features are different than in the training dataset(s) used to train any other model(s) 355. Each model 355 may comprise the same architecture (e.g., Random Forest, XGBoost, etc.) or different architectures (e.g., suitable for the particular data being modeled).

Alternatively, all of the features may be combined into the labeled feature vectors of a single training dataset 315, to be used to train a single model 355. However, the relevant data is typically tracked in different systems (e.g., different CRM systems) which may each track different sets of characteristics and in different time frames. This may make it difficult to incorporate all of data 305 into a single comprehensive model 355. In addition, one desirable feature of a predictive machine-learning model, such as model 355, is interpretability. Interpretability enables organizational users of model 355 to identify areas of concern and formulate appropriate next steps for interventions, for example, to prevent churn or rejection. The use of different models 355, representing different account health categories (e.g., snapshot health vs. transactional health), enables the organizational user to identify strongly and weakly performing customer accounts in each account health category, and extract insights from the differences.

Data may enter data flow 500 from one or a plurality of data sources 510, illustrated as data sources 510A, 510B, . . . , 510N. This data may comprise snapshot data and/or transactional data, as well as other types of data. Data source(s) 510 may comprise one or more of the following:
A CRM system, which may provide the profile characteristics of customer accounts that are tracked by an organizational user, information about engagements of customer accounts with sales and marketing campaigns, interactions between customer accounts and sales representatives by email or calendar, conversion outcomes for historical renewals, upsells, and/or cross-sells, and/or the like.
A MAP system, which may provide engagement activity by customer accounts with marketing campaigns.
A support ticketing system, which may provide information on interactions between customer accounts and an organizational user's support team, such as metrics of the volume, content, severity, resolution time, and/or the like of support tickets that have been opened by customer accounts for product(s) offered by the organizational user. One example of a support ticketing system is the software offered by Zendesk, Inc. of San Francisco, CA.
A customer success (CS) system, which may provide information about interactions between customer accounts and the CS team of the organizational user, such as one or more metrics indicating how connected or engaged each customer account is with CS team members and/or the organizational user as a whole, the sentiment of these interactions, the frequency of these interactions, and/or the like. Examples of CS systems include, without limitation, the software offered by Gainsight Inc. of San Francisco, California, SalesForceDotCom (SFDC) tasks and events in the software provided by Salesforce, the organizational user's email software, such as Outlook™ by Microsoft Corporation of Redmond, Washington, or the like.
Product usage or analytics, which may comprise information about how each customer account interacts with or uses the product(s) offered by the organizational user, such as the number of active users of the product(s), a trend in the number of active users (e.g., daily, weekly, monthly, etc.), a number of different actions performed by the customer account, other metrics of product usage, general product behavior, and/or the like. Product usage may be derived from software tools provided by Mixpanel, Inc. of San Francisco, California, Pendo.io, Inc. of Raleigh, North Carolina, or the like.
Online activity data, which may comprise the website visitation behavior of customer accounts, and/or the like. Online activity data may be obtained (e.g., using a JavaScript web tag on the organizational user's web site) and linked to customer accounts (e.g., de-anonymized based on IP address, domain, cookies, etc.) using, for example, embodiments described in U.S. Pat. No. 10,536,427 (“the '427 patent”), issued on Jan. 14, 2020, and U.S. patent application Ser. No. 18/073,807 (“the '807 application”), filed on Dec. 2, 2022, which are both hereby incorporated herein by reference as if set forth in full, and which may be collectively referred to herein as “the mapping references.”
Customer intent data, which may comprise information about relevant research behaviors by customer accounts. This research behavior may be tied to specific keywords that are relevant to an organizational user's product(s). Customer intent data may be received from one or more third-party data providers, and may be linked to customer accounts using, for example, embodiments described in the mapping references.
Customer satisfaction data, which may comprise net promoter scores, other results of surveys of the customer accounts, and/or the like.

The data, received from all data sources 510, may be input to an account mastering module 520. Different data sources 510 (e.g., different CRM systems) will track customer accounts in different ways and apply unique identifiers. Account mastering module 520 may apply a mastering process that generates a unique cross-platform identifier for each customer account and unifies (e.g., cleans, standardizes, normalizes, etc.) the snapshot data, transactional data, and/or other data for each customer account under the corresponding cross-platform identifier. Example embodiments of account mastering module 520 are described in U.S. Patent Publication No. 2021/0406285, published on Dec. 30, 2021, which is hereby incorporated herein by reference as if set forth in full. The result of account mastering module 520 is a master database of information, including snapshot data and/or transactional data, for each of a plurality of customer accounts for each organizational user. Opportunities (e.g., renewal, upsell, or cross-sell opportunities) may be linked to the cross-platform identifiers for the customer accounts. Advantageously, account mastering module 520 constructs and updates a clean, unified master database from a plurality of disparate data sources 510. The master database may be indexed by the cross-platform identifiers, such that all data for a given customer account may be easily retrieved based on the cross-platform identifier of that customer account.

Profile features 530 may be extracted from data (e.g., snapshot data) in the master database, as discussed elsewhere herein. In an embodiment, the data in master database may be enriched with firmographic and/or technographic data 535 to produce or otherwise inform one or more of the features in profile features 530. The term “firmographic data” refers to characteristics for segmenting businesses. What demographics are to people, firmographics are to businesses, and in the present context, to customer accounts. The term “technographic data” refers to characteristics for segmenting business markets.

Behavioral features 540 may be extracted from data (e.g., transactional data) in the master database, as discussed elsewhere herein. In an embodiment, activities by customer accounts may be binned into an abstracted, higher level, standardized taxonomy 545, when generating behavioral features 540. This reduces the cardinality of the data and facilitates cross-customer modeling. Example embodiments of taxonomy 545 are described in the taxonomy references.

During training, the particular profile features 530 and/or behavioral features 540 may be determined from historical data in the master database using feature engineering, and labeled with historical account outcomes. The feature engineering may include defining a past time window (e.g., a three-month past time window) immediately preceding the time at which the account outcome is to be determined. It should be understood that, in training dataset 315, each feature vector may comprise feature values derived from this past time window immediately preceding the account outcome with which that feature vector is labeled. The features that may be used in behavioral features 540 may be similar to those that are used in the intent models described, for example, in U.S. Pat. No. 9,202,227, issued on Dec. 1, 2015, and U.S. Patent Publication No. 2021/0406933 (“the '933 publication”), published on Dec. 30, 2021, which are both hereby incorporated herein by reference as if set forth in full. For example, potential activities by customer accounts that may be used to derive behavioral features 540 may include, without limitation, keyword research, web visits, engagements with sales or marketing campaigns, product usage, support ticketing, interactions with a CS team or other representative(s) of the organizational user, and/or any other activity that may influence a renewal, upsell, or cross-sell decision.

During operation, the particular profile features 530 and/or behavioral features 540 may be derived from current data (e.g., within the most recent past time window determined for the feature engineering) in the master database. It should be understood that the profile features 530 and/or behavioral features 540 that are used during operation will consist of the same features that are used to train model(s) 355 during training, but will represent current values of those features for customer accounts of interest, and will not be labeled with target values of the account outcome. Rather, the feature values will be input, as a feature vector, to a trained model 355 to produce a predicted account outcome. For example, profile features 530 will be input to trained profile model 355A to predict a profile-based account outcome 550A, and behavioral features 540 will be input to trained behavioral model 355B to predict a behavior-based account outcome 550B.

In an embodiment, an aggregation module 560 aggregates the account outcomes output by each model 355 into a final predicted account outcome. For example, aggregation module 560 may aggregate profile-based account outcome 550A and behavior-based account outcome 550B into a single predicted account outcome. In an embodiment in which each model 355 outputs a probability value, aggregation module 560 may output a composite probability value that is generated as a straight or weighted average of all of the probability values output by models 355. In the case of a weighted average, the weights assigned to the output of each model 355 may be determined heuristically, by another model, or in some other manner. This composite probability value or other representation (e.g., bucket value of strong, medium, or weak) of the overall predicted account outcome may be output to one or more downstream functions 570.

Alternatively or additionally, the account outcome from each model 355 may be used individually by one or more downstream function(s) 570. In the event that all downstream function(s) 570 use individual account outcomes from models 355, aggregation module 560 may be omitted. Thus, the output from each model 355 may be directly provided to each downstream function 570 that uses it.

While only two models 355A and 355B are illustrated, there may be any number of models 355, in addition to, instead of, or utilized as profile model 355A and behavioral model 355B. Examples of specific models 355 include, without limitation, an engagement model, a profile characteristics model, an interactions model, a product usage model, and/or a support ticketing model. Each model 355 may utilize data from the same data sources 510, or different models 355 may be applied to different subsets of data sources 510, to obtain outcomes 550 that can be combined by aggregation module 560 into a single outcome, for example, according to weights assigned to each data source 510 (e.g., as a weighted average). In such a case, more reliable data sources 510 may be weighted more heavily than less reliable data sources 510.

An engagement model may utilize a set of features comprising, for a given customer account, the number of activities attributed to the customer account (e.g., count of actions by action type), the amount of time (e.g., number of days) since the last activity was performed by the customer account, the set of must frequent activities performed by the customer account, the most recent day in which an activity type that has been performed more than the average for all activity types was performed by the customer account (e.g., determined by segregating all activities by activity type, and finding the most recent day in which an activity type whose count is above the average count for all activity types was performed), the most recent day in which a number of activities performed by the customer account exceeded the average number of actions performed by the customer account (e.g., determined by segregating all activities by day of performance, and finding the most recent day on which the number of activities performed exceeded the average of performed activities across all days), the most recent day in which the activity type that has been performed more than any other activity type was performed by the customer account, the job functions of the most active agents of the customer account (e.g., the N most active job functions, where N≥1), the job level of the most active agents of the customer account (e.g., with ties going to the highest job level), and/or the like. One or more, including potentially all, of the above features may be determined within a most recent past time window preceding the time for which the account outcome is to be predicted.

A profile characteristics model may utilize a set of features comprising, for a given customer account, the industry of the customer account, the number of employees at the customer account, technographic information of the customer account, one or more other profile characteristics of the customer account, and/or the like.

An interactions model may utilize a set of features comprising, for a given customer account, the NPS score for the customer account, the average sentiment of interactions between the customer account and the organization user, the frequency of interactions between the customer account and the organizational user, whether c-level employees of the customer account have been engaged by the organizational user, and/or the like. One or more, including potentially all, of the above features may be determined within a most recent past time window preceding the time for which the account outcome is to be predicted.

A product usage model may utilize a set of features comprising, for a given customer account, which employees have been engaged within a most recent past time window preceding the time for which the account outcome is to be predicted.

A support ticketing model may utilize a set of features comprising, for a given customer account, the number of tickets opened by the customer account, the average resolution time for tickets, the average severity of the tickets, and/or the like. One or more, including potentially all, of the above features may be determined within a most recent past time window preceding the time for which the account outcome is to be predicted.

Downstream function(s) 570 are illustrated as downstream functions 570A, 570B, . . . , 570M. Each downstream function 570 may utilize an account outcome output by a single model 355, the individual outcomes output by a plurality of models 355, and/or a composite account outcome output by aggregation module 560. In all cases, each account outcome that is utilized by a downstream function 570 represents a prediction of an account outcome for a particular customer account. For example, the account outcome for each customer account may represent the probability that the customer account will be renewed, that the customer account will churn (i.e., not be renewed), that the customer account will agree to an upsell, that the customer account will not agree to an upsell, that the customer account will agree to a cross-sell, or that the customer account will not agree to a cross-sell.

One example of a downstream function 570 is a report module. The report module may generate reports within a dashboard or other screen of the graphical user interface provided by server application 112 for the organizational user. Within the report, the organizational user may review the predicted account outcomes (e.g., as a probability value, bucket value, etc.) for one or more, including potentially all, customer accounts associated with the organizational user. The organizational user may also sort or rank the customer accounts in the report, for example, to see which customer accounts may require the most attention in order to obtain a positive account outcome (e.g., those accounts with a low likelihood of a positive account outcome).

Another example of a downstream function 570 is an alert module. The alert module may provide an alert to one or more recipients when the probability of a positive account outcome for a customer account drops below a predefined threshold and/or the current contract with the customer account expires within a predefined future time window from the current time. The recipient(s) may include one or more sales team members that are responsible for that customer account. Each alert may be provided in a dashboard or other screen of the graphical user interface for each recipient, sent via email message to an email address of each recipient, sent via text message (e.g., Short Messaging Service (SMS) or Multimedia Messaging Service (MMS) message) to a mobile telephone number of each recipient, sent via an internal messaging app of the organization (e.g., Slack™), and/or the like.

Another example of a downstream function 570 is a segmentation module. The segmentation module may segment customer accounts based on the predicted account outcomes. When the account outcome to be predicted is a renewal or churn, the segmentation module may segment the customer accounts further based on a time duration until the renewal decision is to be made (e.g., the time until the current contract ends). In other words, the segmentation module may create cohorts of customer accounts based on the predicted account outcomes. For example, customer accounts with a low likelihood of a positive account outcome, and potentially sharing one or more other characteristics, may be grouped together for a targeted marketing campaign.

Another example of a downstream function 570 is the orchestration of marketing campaigns. For example, the predicted account outcomes may be provided to the recommendation engine described in U.S. Patent Publication No. 2022/0358522, published on Nov. 10, 2022, which is hereby incorporated herein by reference. For example, a tactic recommendation model of the recommendation engine may be applied to the predicted account outcomes to produce recommended tactics. In the renewal context, a recommended tactic may be to contact a customer account whose contract is about to end (e.g., the current time is within a predefined time period from the future end of the contract) and for whom the probability of a positive outcome is low (e.g., below a predefined threshold). In other words, the organizational user is encouraged to contact those customer accounts which are likely to churn, and therefore, to whom extra attention should be paid in order to maintain their business. In the upsell or cross-sell context, a recommended tactic may be to contact a customer account for whom the probability of a positive outcome is high (e.g., above a predefined threshold). In other words, the organizational user is encouraged to contact those customer accounts from which it is likely that additional business can be obtained. In all contexts, the recommended tactic may comprise topics to be addressed. In an embodiment, the topics in the recommended tactics may be determined based on the account outcomes output by specific models 355. For example, if the interactions model indicates a low likelihood of a positive account outcome, the recommended tactic may emphasize a CS interaction.

Another example of a downstream function 570 is sales intelligence. For example, in the renewal context, a sales intelligence dashboard may display the predicted account outcome for all customer accounts with contract end dates (i.e., renewal deadlines) within a future time window (e.g., the next 30 months) that is defined by the system and/or by the organizational user (e.g., via a filter). Representatives of the organizational user may review the predicted account outcomes to determine on which customer accounts to focus.

Another example of a downstream function 570, is for determining a next best action. For example, the predicted account outcomes may be provided as an input to the intent model or other model described in the '933 publication. In particular, the model may recommend an action to contact a customer account with a low probability of renewal and/or a high probability of an upsell or cross-sell.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive data for at least one customer account;
extract feature values for a set of features for the at least one customer account from the received data;
apply at least one predictive machine-learning model to the feature values to identify a probability of an account outcome, wherein the at least one predictive machine-learning model has been trained on a training dataset comprising a plurality of labeled feature vectors, wherein each of the plurality of labeled feature vectors comprises values for the set of features and is labeled with a ground-truth account outcome; and
provide an output, representing the identified probability of the account outcome, to at least one downstream function.

2. The method of claim 1, wherein the received data comprise snapshot data for the at least one customer account, and wherein the snapshot data comprise a time series of snapshots that each represent a profile of the at least one customer account at a point in time.

3. The method of claim 1, wherein the received data comprise transactional data for the at least one customer account, and wherein the transactional data comprise a time series of activities associated with the at least one customer account.

4. The method of claim 3, wherein the activities comprise visiting a website.

5. The method of claim 3, wherein the activities comprise engaging with a representative of an organization with which the at least one customer has a contract.

6. The method of claim 1, wherein the at least one predictive machine-learning model is a plurality of predictive machine-learning models that are each trained on a separate training dataset, and wherein the plurality of labeled feature vectors in each separate training dataset comprise values for a different set of features than in the separate training dataset used to train any others of the plurality of predictive machine-learning models.

7. The method of claim 6, wherein the received data comprise snapshot data and transactional data for the at least one customer account, wherein the snapshot data comprise a time series of snapshots that each represent a profile of the at least one customer account at a point in time, wherein the transactional data comprise a time series of activities associated with the at least one customer account, wherein a first one of the plurality of predictive machine-learning models is trained on a first separate training dataset comprising profile features derived from the snapshot data, and wherein a second one of the plurality of predictive machine-learning models is trained on a second separate training dataset comprising behavioral features derived from the transactional data.

8. The method of claim 7, wherein the first predictive machine-learning model outputs a first probability value of the account outcome, and wherein the second predictive machine-learning model outputs a second probability value of the account outcome.

9. The method of claim 8, further comprising using the at least one hardware processor to aggregate at least the first probability value and the second probability value into a composite probability value, wherein the output, provided to the at least one downstream function, is based on the composite probability value.

10. The method of claim 9, wherein the composite probability value is a weighted average of at least the first probability value and the second probability value.

11. The method of claim 8, wherein the output, provided to the at least one downstream function, comprises both a first value based on the first probability value, and a second value based on the second probability value.

12. The method of claim 1, wherein the at least one predictive machine-learning model is a classification model, and wherein identifying the probability of an account outcome comprises identifying the probability that the account outcome is within at least one of a plurality of classes.

13. The method of claim 1, wherein the account outcome is a renewal of a contract.

14. The method of claim 1, wherein the account outcome is an upsell of a product.

15. The method of claim 1, wherein the account outcome is a cross-sell of a product.

16. The method of claim 1, further comprising using the at least one hardware processor to train the at least one predictive machine-learning model on the training dataset.

17. The method of claim 1, wherein the received data comprise data received from a plurality of different sources, and wherein the plurality of different sources comprise one or more of a customer relationship management system, a marketing automation platform, a support ticketing system, a customer success system, product usage data, online activity data, customer intent data, or customer satisfaction data.

18. The method of claim 17, further comprising using the at least one hardware processor to:
for each of a plurality of customer accounts, master the data received from the plurality of different sources for the customer account under a unique cross-platform identifier; and
store the mastered data in a master database,
wherein receiving the data for the at least one customer comprises retrieving the data from the master database based on the unique cross-platform identifier of the at least one customer.

19. A system comprising:
at least one hardware processor; and
one or more software modules that are configured to, when executed by the at least one hardware processor,
receive data for at least one customer account,
extract feature values for a set of features for the at least one customer account from the received data,
apply at least one predictive machine-learning model to the feature values to identify a probability of an account outcome, wherein the at least one predictive machine-learning model has been trained on a training dataset comprising a plurality of labeled feature vectors, wherein each of the plurality of labeled feature vectors comprises values for the set of features and is labeled with a ground-truth account outcome, and
provide an output, representing the identified probability of the account outcome, to at least one downstream function.

20. A non-transitory computer-readable medium having instructions stored therein, wherein the instructions, when executed by a processor, cause the processor to:
receive data for at least one customer account;
extract feature values for a set of features for the at least one customer account from the received data;
apply at least one predictive machine-learning model to the feature values to identify a probability of an account outcome, wherein the at least one predictive machine-learning model has been trained on a training dataset comprising a plurality of labeled feature vectors, wherein each of the plurality of labeled feature vectors comprises values for the set of features and is labeled with a ground-truth account outcome; and
provide an output, representing the identified probability of the account outcome, to at least one downstream function.
